(19) United States
(12) Patent Application Publication
(10) Pub. No.: US 2020/0131357 A1
(43) Pub. Date: Apr. 30, 2020

(54) Block Copolymer, Dispersant, Pigment Dispersion Composition, Dye Dispersion Composition and Metal Oxide Dispersion Composition

(71) Applicant: National Tsing Hua University, Hsinchu (TW)

(72) Inventors: Chi-How Peng, Hsinchu (TW); Hung-Hsun Lu, Hsinchu (TW)

(21) Appl. No.: 16/418,089

(22) Filed: May 21, 2019

(30) Foreign Application Priority Data
Oct. 31, 2018 (TW) 107138666

(51) Int. Cl. C08L 53/00; C08K 3/22

(52) U.S. Cl. CPC C08L 53/00; C09D 17/001; C08K 3/22

(57) ABSTRACT

The present disclosure provides a series of block copolymers including a hydrophilic segment and a hydrophobic segment with varied chain length. The hydrophilic segment includes a segment represented by formula (1), and the hydrophobic segment includes a segment represented by formula (2). Formula (1) and formula (2) are defined as in the specification. The block copolymer can be used as a dispersant of a pigment dispersion composition, a metal oxide dispersion composition or a dye dispersion composition.

### CROSS-REFERENCE TO RELATED APPLICATION

This application claims priority to Taiwanese Patent Application No. 107138666 filed Oct. 31, 2018, the disclosure of which is hereby incorporated by reference in its entirety.

### BACKGROUND

### Technical Field

The present disclosure relates to a block copolymer, a dispersant, a pigment dispersion composition, a metal oxide dispersion composition, and a dye dispersion composition. More particularly, the present disclosure relates to a poly(ethylene glycol)-based block copolymer, a dispersant thereof, a pigment dispersion composition thereof, a metal oxide dispersion composition thereof, and a dye dispersion composition thereof.

### Description of Related Art

Generally, the pigments are organic or inorganic molecules which are insoluble in weak solvent (such as water and ethanol). The surface of the commercial pigments is usually modified by ionic moiety to reduce the agglomeration in water. The pigment dispersant is mainly the polymer materials prepared by radical polymerization, but is not usually effective for pigment dispersion. In the formulation, either high content of the pigment dispersant or addition of an organic solvent is required to approach the dispersion of pigments. Accordingly, the manufacturing process using pigments is neither economic nor environmentally friendly.

The humectant, such as propylene glycol, butylene, glycol, glycerin and hyaluronan, are conventionally added in the formulation with dispersants and pigments, resulting in the complexity of formulation and the barrier for the development of new products. Simplification of the formulation would shorten the time required to develop the new products.

Therefore, how to improve the dispersant of the conventional pigments and dyes so as to solve the high content of organic solvent used for the dispersion and conform to the environmental benefits is the goal of the relevant industry.

### SUMMARY

According to one aspect of the present disclosure, a block copolymer is provided. The block copolymer includes a hydrophilic segment and a hydrophobic segment. The hydrophilic segment includes a segment represented by formula (1):

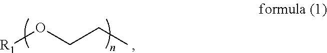

wherein n is a real number of 20 to 200, R₁ is a hydrogen atom, a phenyl group, a carboxyl group, an alkynyl group, an azide group, an amino group, maleimide or an alkyl group. The hydrophobic segment includes a segment represented by formula (2):

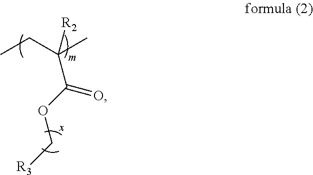

wherein m is a real number of 20 to 150, x is a real number of 0 to 10, R₂ is a hydrogen atom or a methyl group, and R₃ is a methoxy group, a phenyl group, a carboxyl group, an alkynyl group, an azide group, an amino group, maleimide or a methyl group.

According to another aspect of the present disclosure, a dispersant is provided. The dispersant includes the block copolymer according to the aforementioned aspect.

According to further another aspect of the present disclosure, a dye dispersion composition is provided. The dye dispersion composition includes the dispersant according to the aforementioned aspect and a dye.

According to still another aspect of the present disclosure, a pigment dispersion composition is provided. The pigment dispersion composition includes the dispersant according to the aforementioned aspect and a pigment.

According to yet another aspect of the present disclosure, a metal oxide dispersion composition is provided. The metal oxide dispersion composition includes the dispersant according to the aforementioned aspect and a metal oxide, wherein the metal oxide is titanium dioxide, zinc oxide, magnesium oxide, zirconium oxide or aluminum oxide.

### BRIEF DESCRIPTION OF THE DRAWINGS

The patent or application file contains at least one drawing executed in color. Copies of this patent or patent application publication with color drawing(s) will be provided by Office upon request and payment of the necessary fee. The present disclosure can be more fully understood by reading the following detailed description of the embodiment, with reference made to the accompanying drawings as follows:

FIG. 1A is a gel permeation chromatogram for a block copolymer according to Example 1 of the present disclosure.

FIG. 1B is a ¹H-NMR spectrum for a block copolymer according to Example 1 of the present disclosure.

FIG. 2A is a gel permeation chromatogram for a block copolymer according to Example 2 of the present disclosure.

FIG. 2B is a ¹H-NMR spectrum for a block copolymer according to Example 2 of the present disclosure.

FIG. 3A is a gel permeation chromatogram for a block copolymer according to Example 3 of the present disclosure.

FIG. 3B is a ¹H-NMR spectrum for a block copolymer according to Example 3 of the present disclosure.

FIG. 4A is a gel permeation chromatogram for a block copolymer according to Example 4 of the present disclosure.

FIG. 4B is a ¹H-NMR spectrum for a block copolymer according to Example 4 of the present disclosure.

FIG. 5A is a gel permeation chromatogram for a block copolymer according to Example 5 of the present disclosure.

FIG. 5B is a ¹H-NMR spectrum for a block copolymer according to Example 5 of the present disclosure.

FIG. 6A is a schematic view for a red segment dispersion composition without adding a dispersant according to Comparative Example 1 of the present disclosure.

FIG. 6B is a schematic view for a red pigment dispersion composition adding a dispersant according to Example 6 of the present disclosure.

FIG. 7A is a graph for the change of the particle size of the red pigment dispersion composition at 4° C. for 7 consecutive days according to Example 6 of the present disclosure.

FIG. 7B is a graph for the change of the particle size of the red pigment dispersion composition at 25° C. for 7 consecutive days according to Example 6 of the present disclosure.

FIG. 7C is a graph for the change of the particle size of the red pigment dispersion composition at 70° C. for 7 consecutive days according to Example 6 of the present disclosure.

### DETAILED DESCRIPTION

The use of a block copolymer is provided in the present disclosure, particularly the use of the block copolymer is applied for the dispersion of a pigment and a dye or a dye dispersion composition. The effect of the dispersion of the block copolymer in the dye, the pigment and the metal oxide is evaluated by the experiment of different segment combination.

### A Composition of a Block Copolymer and a Dispersant

A block copolymer according to one embodiment of the present disclosure includes a hydrophilic segment and a hydrophobic segment. The hydrophilic segment includes a segment represented by formula (1):

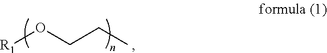

wherein n is a real number of 20 to 200, R₁ is an organic functional group such as a hydrogen atom, a phenyl group, a carboxyl group, an alkynyl group, an azide group, an amino group, maleimide or an alkyl group. The formula (1) is a segment with a repeating unit of ethylene glycol (CH₂CH₂O). In the formula (1), n is a number of the repeating unit of the ethylene glycol, preferably n is a real number of 30 to 150, more preferably n is a real number of 45 to 113. When the number of the repeating unit of the ethylene glycol is less than 20, the block copolymer may not show the sufficient hydrophilic property. When the number of the repeating unit of the ethylene glycol is higher than 200, the viscosity of the block copolymer will result in a gel which cannot be used as the dispersant. Furthermore, the specific example of the alkyl group represented by the terminal group R₁ of the segment represented by the formula (1), includes but is not limited to a methyl group, an ethyl group, a n-propyl group, an isopropyl group, a n-butyl group, an isobutyl group, a tert-butyl group, a n-pentyl group, an isopentyl group, a neopentyl group, a cyclopropyl group, a cyclobutyl group, a cyclopentyl group and a cyclohexyl group. Given that the molecular weight of the hydrophilic segment, R₁ is preferably a hydrogen atom or a methyl group, and the specific example of the formula (1) is preferably a poly(ethylene glycol) (PEG) segment. More specifically, the segment represented by the formula (1) in the hydrophilic segment can include one type of the monomer unit or a plurality of types of the monomer units. The partial structure included in the hydrophilic segment can be only the segment represented by the formula (1), or other partial structures can be included in the hydrophilic segment. The other partial structures can be included in the hydrophilic segment in any of the embodiments of random copolymerization or block copolymerization. The hydrophilic segment preferably includes 80 wt % to 100 wt % of the segment represented by the formula (1).

The hydrophobic segment includes a segment represented by formula (2):

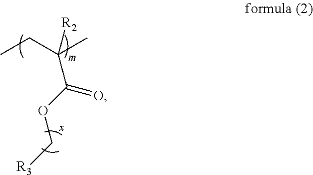

wherein m is a real number of 20 to 150, x is a real number of 0 to 10, R₂ is a hydrogen atom or a methyl group, and R₃ is an organic functional group such as a methoxy group, a phenyl group, a carboxyl group, an alkynyl group, an azide group, an amino group, maleimide or a methyl group. The formula (2) is a segment with the repeating unit of methyl methacrylate (CH₂CCH₃COOCH₃). In the formula (2), m represents the number of the repeating unit of methyl methacrylate, and could be adjusted depending on the required molecular weight of the block copolymer. The number of m is estimated by the integration of peaks shown in ¹H nuclear magnetic resonance (¹H-NMR) spectrum, preferably m is a real number of 30 to 100, more preferably m is a real number of 36 to 80. Furthermore, x is the real number of 0 to 10 carbon atoms of the segment represented by the formula (2), which represents that the functional group can be an alkyl group having 1 to 10 carbon atoms. The specific examples of the alkyl group from 1 to 10 carbon atoms can be included but not limited to a linear chain or branched chain alkyl groups, such as a methyl group, an ethyl group, a n-propyl group, an isopropyl group, a n-butyl group, an isobutyl group, a sec-butyl group, a tert-butyl group, a pentyl group, a hexyl group, a heptyl group, an octyl group, a pentyl group, and a decyl group. The specific examples of methacrylate can be included but not limited to methyl(meth)acrylate, ethyl(meth)acrylate, propyl(meth)acrylate, n-butyl(meth)acrylate, isobutyl(meth)acrylate, sec-butyl(meth)acrylate, tert-butyl(meth)acrylate, cyclohexyl(meth)acrylate, 2-ethylhexyl(meth)acrylate, and the specific example of the formula (2) is preferably a methyl(meth)acrylate (PMMA) segment. More specifically, the segment represented by the formula (2) in the hydrophobic segment can include one type of the monomer unit or a plurality of types of the monomer units. The partial structure included in the hydrophobic segment can be only the segment represented by the formula (2), or other partial structures can be included in the hydrophobic segment. The other partial structures can be included in the hydrophobic segment in any of the embodiments of random copolymerization or block copolymerization. The hydrophobic segment preferably includes 80 wt % to 100 wt % of the segment represented by the formula (2).

The method used to produce the block copolymer of the present embodiment is controlled radical polymerization, which can form the polymer evenly and easily. The block copolymers are obtained by sequentially addition of monomers to a polymerization reaction. The hydrophilic segment is produced first, and then the monomer of the hydrophobic segment is polymerized with the hydrophilic segment. Or the hydrophobic segment is produced first, and then the monomer of the hydrophilic segment is polymerized with the hydrophobic segment. In addition, the hydrophilic segment and the hydrophobic segment can be separately produced by the polymerization of monomers so as to couple the hydrophilic segment and the hydrophobic segment to form the block copolymer. The method for producing the block copolymer of the present embodiment is not limited to the aforementioned.

In the block copolymer of the present embodiment, a weight ratio of the hydrophilic segment to the hydrophobic segment (the hydrophilic segment: the hydrophobic segment) preferably ranges from 90:10 to 10:90. A number-average molecular weight of the block copolymer preferably ranges from 2000 to 20000 g/mol, wherein the number-average molecular weight of the block copolymer is obtained by gel permeation chromatography (GPC) using tetra-hydrofuran (THF) as an eluent. The principle of GPC for the measurement of molecular weight of polymer is that the different particle size formed from different molecular weight of the block copolymer causes the different residence time in the column and thus the block copolymer can be separated. The block copolymer with higher molecular weight will stay shorter in the column. In contrast, the block copolymer with lower molecular weight will pass through the hole of the particles filled in column and thus stay longer in the column, resulting in a longer elution time. Therefore, the distribution of the molecular weight and the average molecular weight of the block copolymer can be measured by gel permeation chromatography. A polymer dispersity index (PDI) of the block copolymer preferably ranges from 1.05 to 2.10, and the polymer dispersity index is used to describe the distribution of the molecular weight of the polymer. The polymer dispersity index is calculated as the weight average molecular weight (M_{w}) of the polymer divided by the number average molecular weight (Mₙ) of the polymer. When the PDI value is closer to 1, the molecular weight of the polymer is more uniform.

The block copolymer of the present embodiment can be used as a dispersant. The dispersant is a surfactant with hydrophilic and hydrophobic properties, and thus used to disperse the solids and liquid particles of pigments or dyes which are difficult to dissolve in solvents so as to reduce the interfacial tension between liquid-liquid and solid-solid. At the same time, the dispersant can also prevent the sedimentation and agglomeration of the particles and increase the compatibility thereof.

The block copolymer of the present embodiment, the hydrophilic segment represented by the formula (1) has the properties of the water-soluble, the high wettability, and the high affinity with water. On the other hand, the hydrophobic segment represented by the formula (2) has the high adhesion to the surface of pigments and dyes. Therefore, when the block copolymer of the present disclosure is used as the pigment dispersant or the dye dispersant in aqueous medium, the hydrophobic segment will adsorb the surface of pigment or dye, and then the hydrophilic segment will wet the pigment or the dye in the aqueous medium so as to promote the dispersion of pigment or dye.

### A Pigment Dispersion Composition, a Metal Oxide Dispersion Composition and a Dye Dispersion Composition

A pigment dispersion composition according to another embodiment of the present disclosure includes a dispersant of the above block copolymer, a pigment and a solvent. In the pigment dispersion composition of the present embodiment, based on 10 to 20 parts by weight of the pigment, the content of the dispersant is 5 to 10 parts by weight. If the content of the dispersant is too low, the pigment cannot be dispersed sufficiently. If the content of the dispersant is too high, the dispersant that is not adsorbed to the pigment will remain in the solvent and cause the inefficient dispersion.

Specifically, the pigment dispersion composition of the present embodiment can be either an organic or an inorganic pigment. The examples of the color pigment can be included but not limited to red pigments, blue pigments, yellow pigments, orange pigments, green pigments, violet pigments and white pigments. The pigment contained in the pigment dispersion composition can be one type or a plurality of types. Specific examples of the pigment can be included but not limited to the red pigments, such as C.I. Pigment Red 7, 9, 14, 41, 48:1, 48:2, 48:3, 48:4, 81:1, 81:3, 122, 123, 146, 149, 168, 177, 178, 179, 187, 200, 202, 208, 210, 215, 224, 254, 255 and 264; the blue pigments, such as C.I. Pigment Blue 15, 15:2, 15:3, 15:4, 15:6, 16, 22 and 60; the yellow pigments, such as C.I. Pigment Yellow 1, 3, 5, 6, 14, 55, 60, 61, 62, 63, 65, 73, 74, 77, 81, 93, 97, 98, 104, 108, 110, 128, 138, 139, 147, 150, 151, 154, 155, 166, 167, 168, 170, 180, 188, 193, 194 and 213; the orange pigments, such as C.I. Pigment Orange 36, 38 and 43; the green pigments, such as C.I. Pigment Green 7, 36 and 58; and the violet pigments, such as C.I. Pigment Violet 19, 23, 32 and 50. The specific examples of the pigment of the present disclosure are preferably C.I. Pigment Red 210, 215, 224, 254, 255 and 264, and C.I. Pigment Blue 15, 15:2, 15:3, 15:4, 15:6, 16, 22 and 60.

A metal oxide dispersion composition according to further another embodiment of the present disclosure includes a dispersant of the above block copolymer, a metal oxide and a solvent. The metal oxide can be used as a white pigment, that is, the metal oxide of the present embodiment can be a pigment dispersion composition. Specific examples of the metal oxide can be included but not limited to the metal oxide, such as titanium dioxide, zinc oxide, magnesium oxide, zirconium oxide and aluminum oxide. In the view of the high coloring and reflectivity, the metal oxide of the present embodiment is preferably titanium dioxide.

A dye dispersion composition according to still another embodiment of the present disclosure includes a dispersant of the above block copolymer, a dye and a solvent. In the dye dispersion composition of the present embodiment, based on 10 to 20 parts by weight of the dye, the content of the dispersant is 5 to 10 parts by weight. If the content of the dispersant is too low, the dye cannot be dispersed sufficiently. If the content of the dispersant is too high, the dispersant that is not adsorbed to the dye will remain in the solvent and cause the inefficient dispersion.

Specifically, the dye in the dye dispersion composition of the present embodiment does not have the water-soluble group, so that it requires the dispersant to disperse the dye in water evenly. The disperse dyes can include disperse red, disperse blue, disperse yellow, disperse orange, and also can be mixed with the several different disperse dyes in a certain proportion so as to obtain disperse dyes, such as disperse black, disperse green, and disperse violet. The dye contained in the dye dispersion composition can be one type or a plurality of types. Specific examples of the dye can be included but not limited to the red dyes, such as C.I. Disperse Red 1, 4, 5, 7, 13, 17, 19, 43, 50, 54, 58, 60, 65, 72, 73, 88, 117, 137, 143, 199 and 210; the blue dyes, such as C.I. Disperse Blue, 3, 14, 26, 27, 56, 60, 72, 73, 79, 81, 87, 106, 124, 134, 149, 197, 198, 211 and 214; the yellow dyes, such as C.I. Disperse Yellow 1, 3, 4, 5, 7, 13, 23, 31, 49, 50, 51, 54, 60, 64, 66, 68, 79, 82, 88, 90, 93, 102, 114 and 124; the orange dyes, such as C.I. Disperse Orange 1, 5, 13, 25, 29, 30, 31, 44, 57, 72 and 73; the green dyes, such as C.I. Disperse Green 6 and 9; and the violet dyes, such as C.I. Disperse Violet 1, 4, 6, 8, 12, 23, 26, 27, 28, 31 and 33. The specific examples of the dye of the present disclosure are preferably C.I. Disperse Red 1, 4 and 54 and C.I. Disperse Blue 3 and 27.

The solvent of the pigment dispersion composition, the metal oxide dispersion composition and the dye dispersion composition of the present disclosure can be water or an alcohol solvent, and also can mix the above one or more solvent. The alcohol solvent can be methanol, ethanol, n-propanol, isopropanol, n-butanol, sec-butanol and tert-butanol. The solvent of the present disclosure is preferably the mixed solvent of methanol, isopropanol and water.

The pigment dispersion composition, the metal oxide dispersion composition and the dye dispersion composition of the present disclosure can be obtained by using a dispersion mixer, such as a ball mill, a bead mill, a dispersion agitator, and dye oscillator so as to mix the pigment, the metal oxide, the dye, the dispersant and the solvent. The above method is not limited thereto.

Therefore, the pigment dispersion composition, the metal oxide dispersion composition and the dye dispersion composition of the present disclosure can be stably dispersed in an aqueous phase, and have the characteristics, such as storage stability and environmental friendly in a nano-scale. The applications of these dispersants include the printed circuit board industry, the coating, the fabric dye and the ink of the inkjet printer.

### Example

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### A Material Analysis of Block Copolymer

The block copolymer of the present disclosure is formed by a hydrophilic segment (having a PEG segment) and a hydrophobic segment (having a PMMA segment) using controlled radical polymerization. The chemical structure of the block copolymer of the present disclosure is shown as followings:

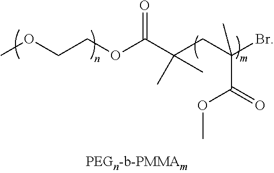

PEG₁₁₃ or PEG₄₅ is utilized as a reference segment of PEG to polymerize with PMMA, forming the dispersant with different molecular weight. The use of PEG₁₁₃ and PEG₄₅ is due to the advantages of commercial availability, low cost, and ease for experiment operation.

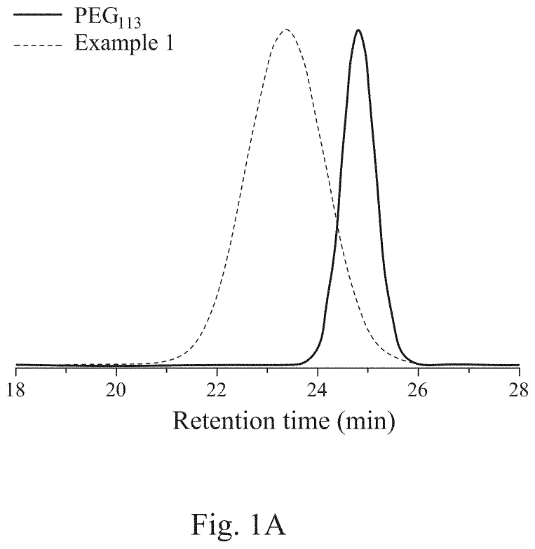

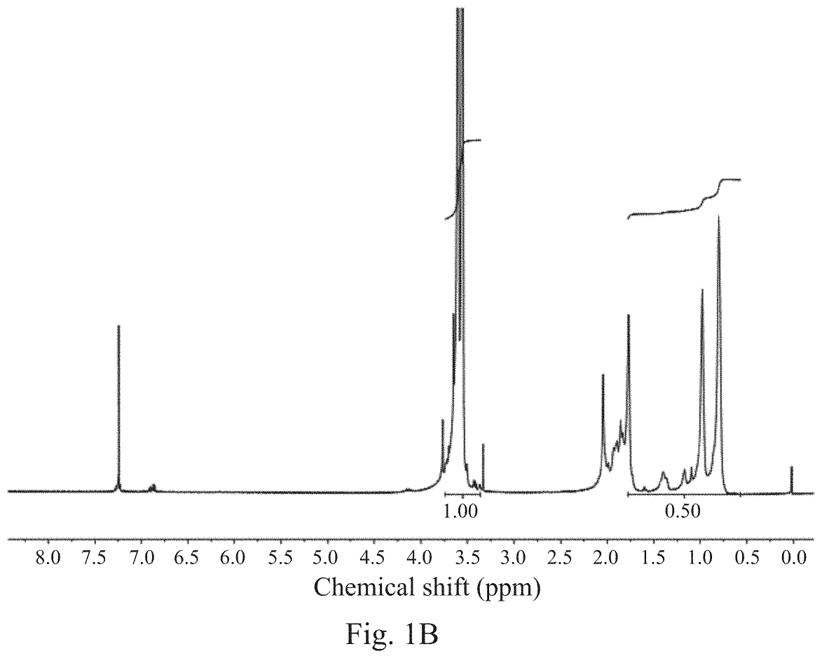

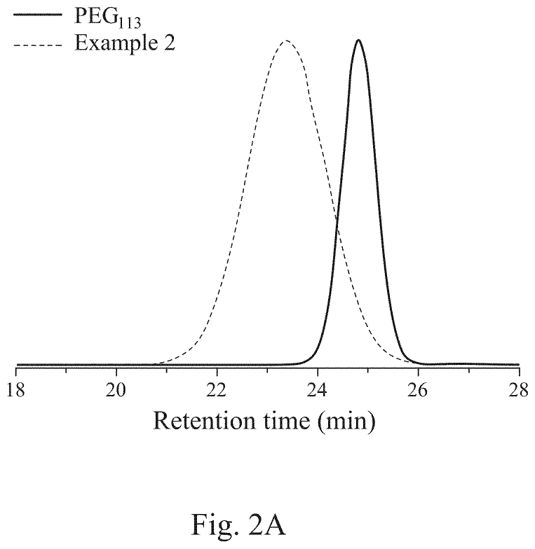

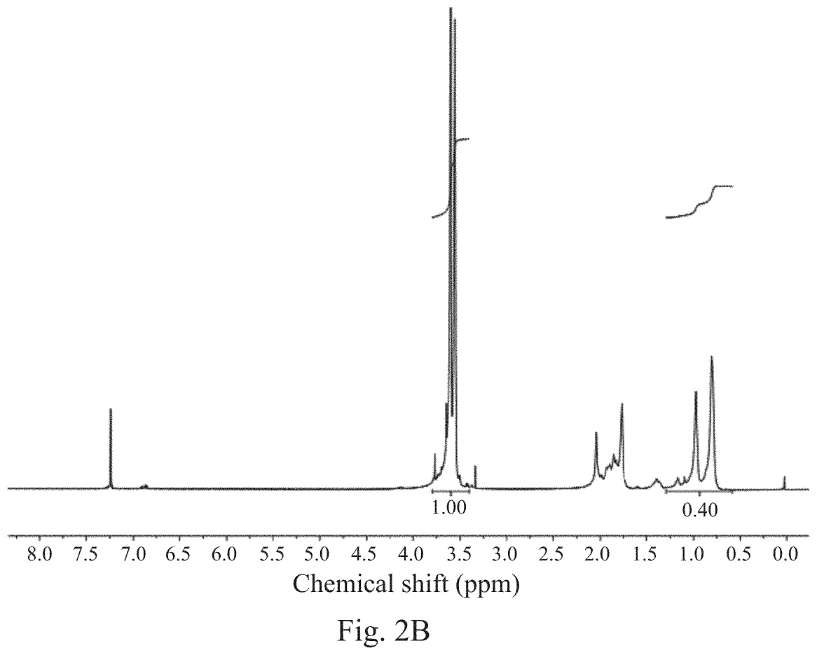

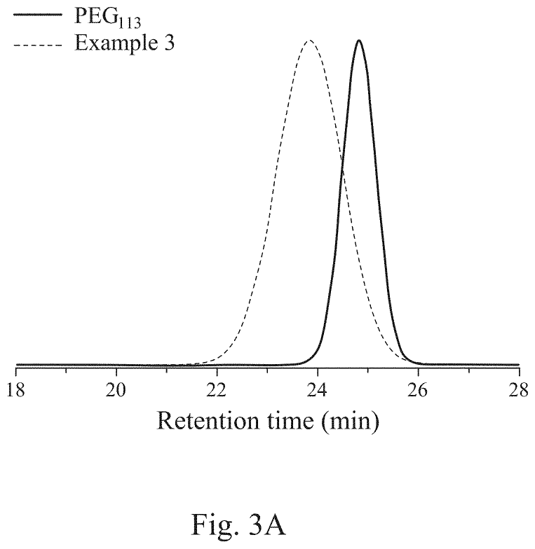

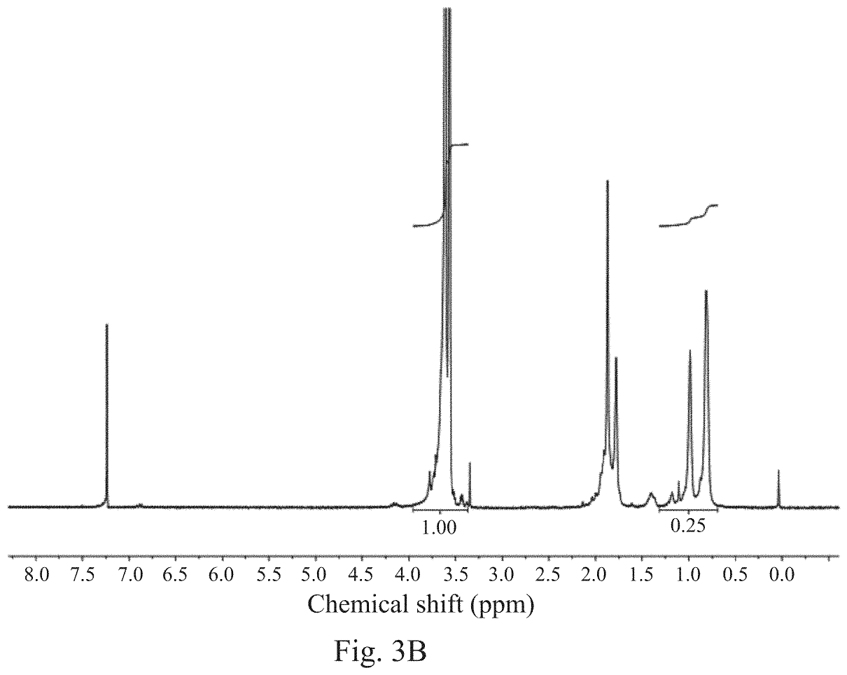

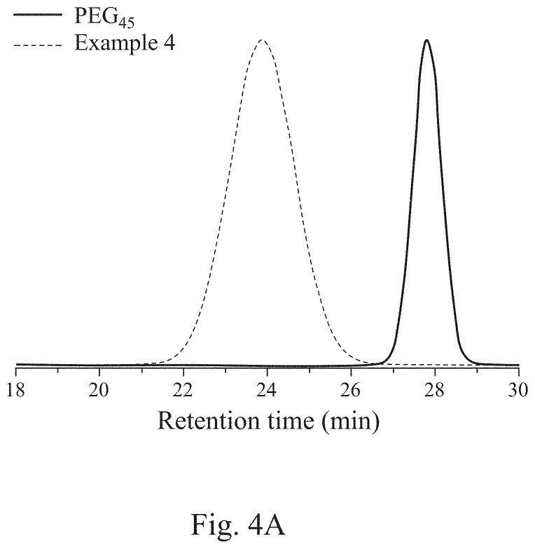

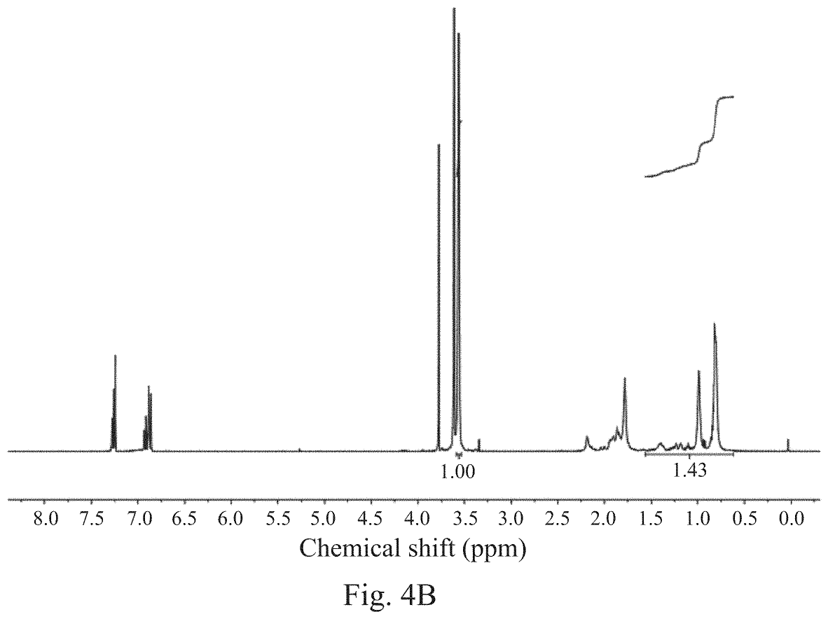

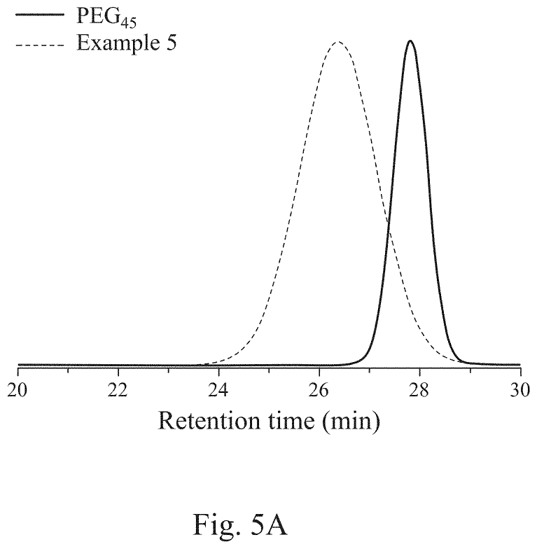

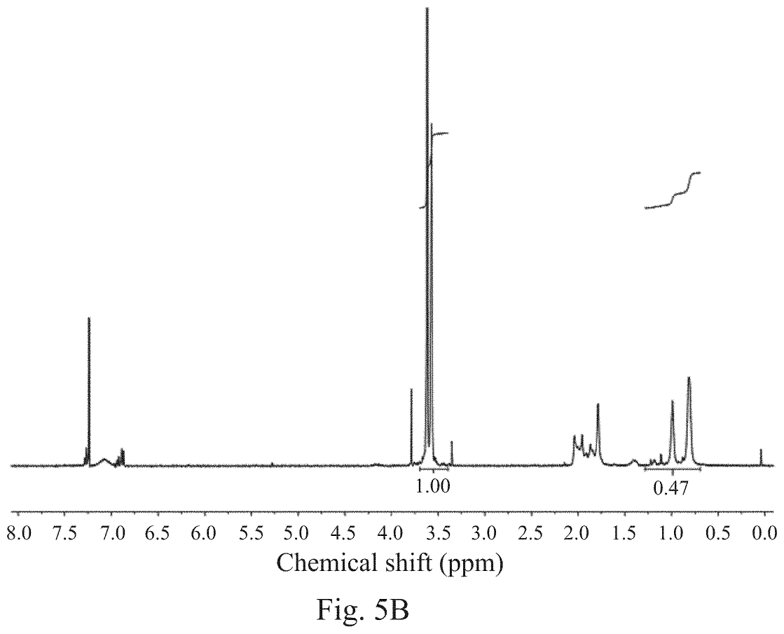

Please refer to FIGS. 1A, 2A, 3A, 4A and 5A. FIG. 1A is a gel permeation chromatogram for a block copolymer according to Example 1 of the present disclosure. FIG. 2A is a gel permeation chromatogram for a block copolymer according to Example 2 of the present disclosure. FIG. 3A is a gel permeation chromatogram for a block copolymer according to Example 3 of the present disclosure. FIG. 4A is a gel permeation chromatogram for a block copolymer according to Example 4 of the present disclosure. FIG. 5A is a gel permeation chromatogram for a block copolymer according to Example 5 of the present disclosure. The number average molecular weight (M_{n,GPC}), the weight average molecular weight (M_{w,GPC}), the Z average molecular weight (M_{z,GPC}) and the polymer dispersity index (PDI) of Example 1, Example 2, Example 3, Example 4 and Example 5 are measured by gel permeation chromatography (GPC). The polymer dispersity index (PDI) is calculated as the weight average molecular weight (M_{w,GPC}) divided by the number average molecular weight (M_{n,GPC}).

Please refer to FIGS. 1B, 2B, 3B, 4B and 5B. FIG. 1B is a ¹H-NMR spectrum for a block copolymer according to Example 1 of the present disclosure. FIG. 2B is a ¹H-NMR spectrum for a block copolymer according to Example 2 of the present disclosure. FIG. 3B is a ¹H-NMR spectrum for a block copolymer according to Example 3 of the present disclosure. FIG. 4B is a ¹H-NMR spectrum for a block copolymer according to Example 4 of the present disclosure. FIG. 5B is a ¹H-NMR spectrum for a block copolymer according to Example 5 of the present disclosure. The ¹H-NMR spectrum is measured by nuclear magnetic resonance (NMR) so as to confirm the molecular structure, and the copolymer composition and the number average molecular weight (M_{n,NMR}) of the copolymer can also be determined. Therefore, the repeating unit number of the PMMA segment of the block copolymer of Example 1, Example 2, Example 3, Example 4 and Example 5 can be inferred from the results of nuclear magnetic resonance (NMR). The block copolymer of Example 1, Example 2, Example 3, Example 4 and Example 5 is PEG₁₁₃-b-PMMA₈₀, PEG₁₁₃-b-PMMA₆₀, PEG₁₁₃-b-PMMA₃₆, PEG₄₅-b-PMMA₁₀₀ and PEG₄₅-b-PMMA₃₀, respectively.

Example 1 (PEG₁₁₃-b-PMMA₈₀), Example 2 (PEG₁₁₃-b-PMMA₆₀), Example 3 (PEG₁₁₃-b-PMMA₃₆), Example 4 (PEG₄₅-b-PMMA₁₀₀) and Example 5 (PEG₄₅-b-PMMA₃₀) of the present disclosure are performed the material analysis, and the results are shown in Table 1.

TABLE 1

| Block copolymer | M_{n, GPC} | M_{w, GPC} | M_{z, GPC} | PDI | M_{n, NMR} |
|---|---|---|---|---|---|
| Example 1 | 14,300 | 17,000 | 21,000 | 1.20 | 13,000 |
| Example 2 | 12,500 | 15,000 | 18,200 | 1.19 | 11,000 |
| Example 3 | 8,000 | 9,200 | 11,000 | 1.15 | 8,600 |
| Example 4 | 11,500 | 14,000 | 16,300 | 1.25 | 12,000 |
| Example 5 | 4,500 | 5,500 | 7,300 | 1.23 | 5,000 |

As shown in Table 1, the polymer dispersity index (PDI) of the block copolymer of Example 1, Example 2, Example 3, Example 4 and Example 5 of the present disclosure ranges from 1.15 to 1.25, wherein the PDI value is closer to 1, the molecular weight of the polymer is more uniform. The results indicate that the molecular weight of the block copolymer PEGₙ-b-PMMAₘ is distributed uniformly, and the block copolymer can be used as the dispersant of the pigment dispersion composition, the metal oxide dispersion composition and the dye dispersion composition. The analysis and the evaluation of high-temperature storage stability of the dye dispersion composition, the pigment dispersion composition and the metal oxide dispersion composition can be performed using the block copolymer with varied ratio of the hydrophilic and hydrophobic segments and the different solvents for dispersion.

### An Analysis of a Red Dye Dispersion Composition

Based on 10 to 20 parts by weight of the red dye of C.I. Disperse Red 1, 4 and 54, the block copolymers of Example 1, Example 2, and Example 3 are used as the dispersants with 5 to 10 parts by weight to mix with proper amount of solvent, which is a mixture of an alcohol and pure water. Then, the whole solution is stirred by a ball mill for 2 to 5 hours. The ball mill contains the zirconia beads, which will be removed by filtration to obtain a red dye dispersion composition. The average Z value (Z_{avg}), the polymer dispersity index (PDI) and the particle size (D50, D90, D95) are shown in Table 2.

TABLE 2

| Block | | | Z_{avg} | | D50 | D90 | D95 |
|---|---|---|---|---|---|---|---|
| copolymer | M_{n,NMR} | solvent | (nm) | PDI | (nm) | (nm) | (nm) |
| Example 1 | 13,000 | methanol/ | 185.1 | 0.142 | 203 | 337 | 382 |
| | | pure water | | | | | |
| Example 2 | 11,000 | isopropyl alcohol/ | 476.3 | 0.428 | 609 | 1290 | 1660 |
| | | pure water | | | | | |
| Example 3 | 8,600 | isopropyl alcohol/ | 251.6 | 0.177 | 279 | 471 | 536 |
| | | pure water | | | | | |
| | | methanol/pure | 410.5 | 0.254 | 453 | 838 | 1000 |
| | | water | | | | | |

As shown in Table 2, the smallest particle size of the red dye dispersion composition occurred when the block copolymer of Example 1 and Example 3 used as the dispersant, indicating that the block copolymer of Example 1 and Example 3 are good dispersants. The solvent of Example 3 is a mixture of isopropyl alcohol and pure water.

### High-Temperature Storage Stability of the Red Dye Dispersion Composition

Furthermore, the red dye dispersion composition using the block copolymer of Example 1 and Example 3 as the dispersant are selected to be evaluated for high-temperature storage stability. The test is performed under 70° C. for 7 consecutive days to observe the change of average Z value (ΔZ_{avg}, nm), average Z value rate (ΔZ_{avg}, %), polymer dispersity index (ΔPDI), and particle size (ΔD50, ΔD90, ΔD95), which are shown in Table 3.

TABLE 3

| Block | | ΔZ_{avg} | ΔZ_{avg} | | ΔD50 | ΔD90 | ΔD95 |
|---|---|---|---|---|---|---|---|
| copolymer | solvent | (nm) | (%) | ΔPDI | (nm) | (nm) | (nm) |
| Example 1 | methanol/ | 1.2 | 0.65 | −0.026 | −1 | −12 | −17 |
| | pure water | | | | | | |
| Example 3 | isopropyl | −10.4 | 4.13 | −0.007 | −15 | −6 | −3 |
| | alcohol/ | | | | | | |
| | pure water | | | | | | |
| | methanol/ | | | | | | |
| | pure water | −43.1 | 10.5 | 0.046 | −66 | −182 | −239 |

As shown in Table 3, the red dye dispersion composition using the block copolymer of Example 1 and Example 3 as the dispersant lead to a smaller change in average Z value, polymer dispersity index (ΔPDI), and particle size (ΔD50, ΔD90, ΔD95), indicating these two conditions have a good high-temperature storage stability. The solvent of Example 3 is a mixture of isopropyl alcohol and pure water.

### An Analysis of a Blue Dye Dispersion Composition

Based on 10 to 20 parts by weight of the blue dye of C.I. Disperse Blue 3 and 27, the block copolymers of Example 2 and Example 3 are used as the dispersants with 5 to 10 parts by weight to mix with proper amount of solvent, which is a mixture of an alcohol and pure water. Then, the whole solution is stirred by a ball mill for 2 to 5 hours. The ball mill contains the zirconia beads, which will be removed by filtration to obtain a blue dye dispersion composition. The average Z value (Z_{avg}), the polymer dispersity index (PDI) and the particle size (D50, D90, D95) are shown in Table 4.

TABLE 4

| Block | | | Z_{avg} | | D50 | D90 | D95 |
|---|---|---|---|---|---|---|---|
| copolymer | M_{n,NMR} | solvent | (nm) | PDI | (nm) | (nm) | (nm) |
| Example 2 | 11,000 | isopropyl alcohol/ | 422.5 | 0.330 | 474 | 1330 | 2020 |
| | | pure water | | | | | |
| Example 3 | 8,600 | isopropyl alcohol/ | 231.6 | 0.202 | 267 | 477 | 550 |
| | | pure water | | | | | |

As shown in Table 4, the smallest particle size of the blue dye dispersion composition occurred when the block copolymer of Example 3 used as the dispersant, indicating that the block copolymer of Example 3 is a good dispersant.

### High-Temperature Storage Stability of the Blue Dye Dispersion Composition

Furthermore, the blue dye dispersion composition using the block copolymer of Example 3 as the dispersant is selected to be evaluated for high-temperature storage stability. The test is performed under 70° C. for 7 consecutive days to observe the change of average Z value (ΔZ_{avg}, nm), average Z value rate (ΔZ_{avg}, %), polymer dispersity index (ΔPDI), and particle size (ΔD50, ΔD90, ΔD95), which are shown in Table 5.

TABLE 5

| Block | | ΔZ_{avg} | ΔZ_{avg} | | ΔD50 | ΔD90 | ΔD95 |
|---|---|---|---|---|---|---|---|
| copolymer | solvent | (nm) | (%) | ΔPDI | (nm) | (nm) | (nm) |
| Example 1 | isopropyl | 22.7 | 9.8 | −0.004 | 21 | 18 | 14 |
| | alcohol/ | | | | | | |
| | pure water | | | | | | |

As shown in Table 5, the blue dye dispersion composition using the block copolymer of Example 3 as the dispersant lead to a smaller change in average Z value, polymer dispersity index (ΔPDI), and particle size (ΔD50, ΔD90, ΔD95), indicating this condition has a good high-temperature storage stability.

The results of red dye dispersion composition and blue dye dispersion composition indicate that both red dye and blue dye can be dispersed to small particle size with high-temperature storage stability by using the block copolymer of Example 3.

### An Analysis of a Red Pigment Dispersion Composition

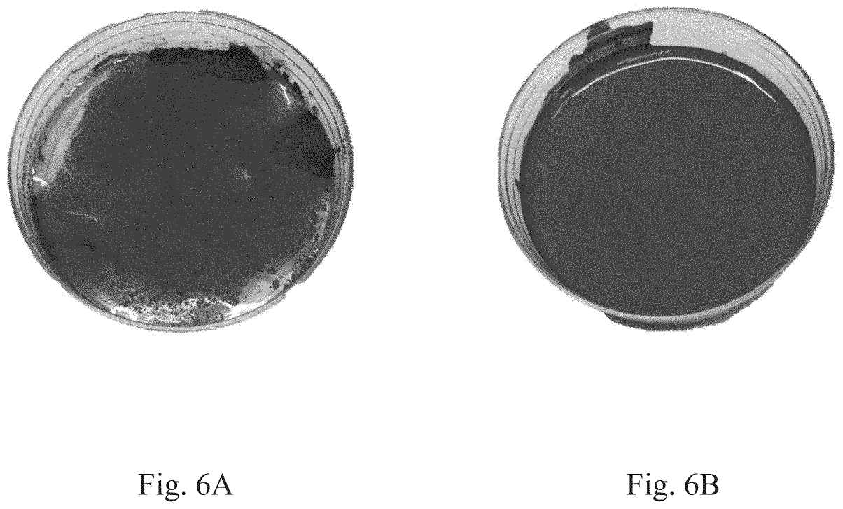

Please refer to FIGS. 6A and 6B. FIG. 6A is a scheme view for a red pigment dispersion composition without adding a dispersant according to Comparative Example 1 of the present disclosure. FIG. 6B is a scheme view for a red pigment dispersion composition adding a dispersant according to Example 6 of the present disclosure. The preparation of Example 6 is based on 10 to 20 parts by weight of the red pigment of C.I. Pigment Red 254, the block copolymer of PEGₙ-b-PMMAₘ is used as the dispersant with 5 to 10 parts by weight to mix with proper amount of solvent, which is pure water. Then, the whole solution is stirred by a ball mill for 2 to 5 hours. The ball mill contains the zirconia beads, which will be removed by filtration to obtain a red pigment dispersion composition. As shown in FIGS. 6A and 6B, the red pigment dispersion composition with the dispersant showed an evenly dispersed the red pigment. The result indicates that the block copolymer of PEGₙ-b-PMMAₘ used as the dispersant has a good effect of dispersion.

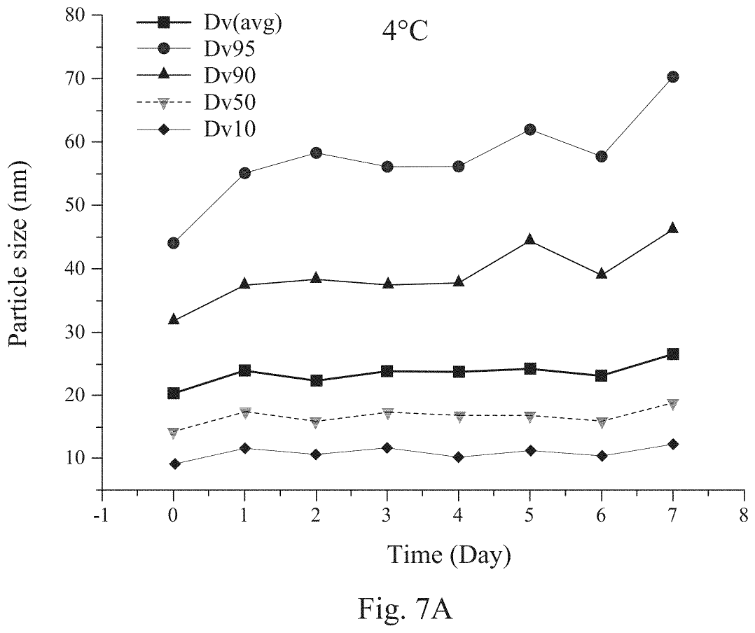

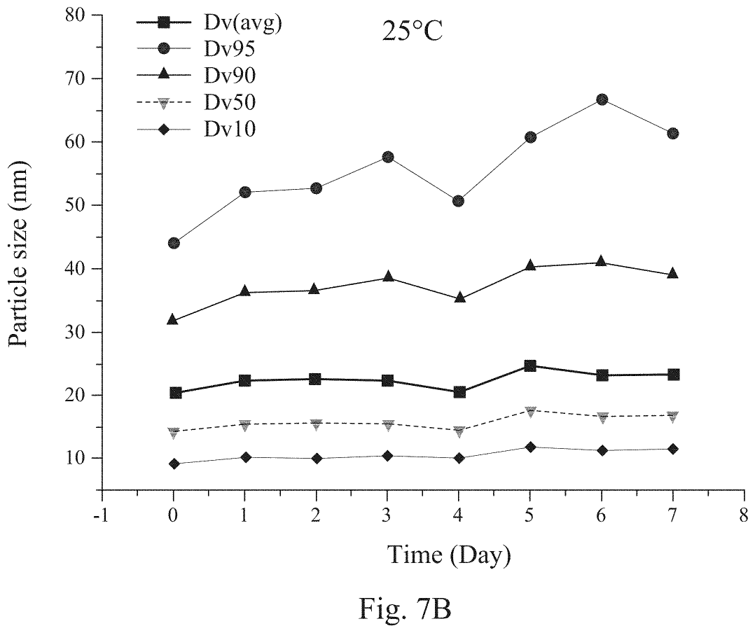

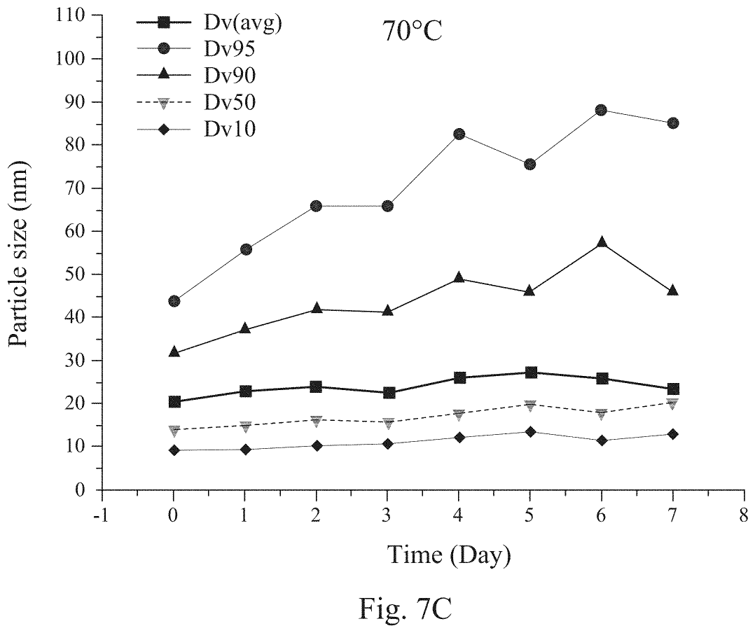

Please refer to FIGS. 7A, 7B and 7C. FIG. 7A is a graph for the change of the particle size of the red pigment dispersion composition at 4° C. for 7 consecutive days according to Example 6 of the present disclosure. FIG. 7B is a graph for the change of the particle size of the red pigment dispersion composition at 25° C. for 7 consecutive days according to Example 6 of the present disclosure. FIG. 7C is a graph for the change of the particle size of the red pigment dispersion composition at 70° C. for 7 consecutive days according to Example 6 of the present disclosure. As shown in FIGS. 7A, 7B and 7C, the change of average particle size of the red pigment dispersion composition of Example 6 of the present disclosure observed at 4° C., 25° C. and 70° C. for 7 consecutive days is small, indicating that the block copolymer of PEGₙ-b-PMMAₘ used as the dispersant in the red pigment dispersion composition has a high-temperature storage stability.

### An Analysis of a Metal Oxide Dispersion Composition

Based on 10 to 20 parts by weight of titanium dioxide, the block copolymers of Example 2 and Example 3 are used as the dispersants with 5 to 10 parts by weight to mix with proper amount of solvent, which is a mixture of an alcohol and pure water. Then, the whole solution is stirred by a ball mill for 2 to 5 hours. The ball mill contains the zirconia beads, which will be removed by filtration to obtain a metal oxide dispersion composition. The solid content and the particle size (D50, D95) are shown in Table 6.

TABLE 6

| Block | | | solid content | D50 | D95 |
|---|---|---|---|---|---|
| copolymer | M_{n, NMR} | solvent | (%) | (nm) | (nm) |
| Example 2 | 11,000 | isopropyl alcohol/ | 25 | 411 | 511 |
| | | pure water | | | |
| | | methanol/ | 20 | 633 | 1330 |
| | | pure water | | | |
| Example 3 | 8,600 | isopropyl alcohol/ | 30 | 389 | 623 |
| | | pure water | | | |
| | | methanol/ | 20 | 516 | 1130 |
| | | pure water | | | |

As shown in Table 6, the smallest particle size of the metal oxide dispersion composition occurred when the block copolymer of Example 2 and Example 3 used as the dispersant, indicating that the block copolymers of Example 2 and Example 3 are good dispersants. The solvent of Example 2 and Example 3 is the mixture of isopropyl alcohol and pure water.

In conclusion, the block copolymers of the present disclosure are controlled the chain length of the hydrophilic segment and the hydrophobic segment to copolymerize the block copolymers of Example 1 to Example 5. The block copolymers are used as the dispersant in the pigment dispersion composition, the dye dispersion composition, and the metal oxide dispersion composition. Observing the change of particle size and stability of storage, indicating that the block copolymers of the present disclosure can well disperse the pigment, the dye, and the metal oxide in the aqueous medium because the block copolymers of the present disclosure have both hydrophilic and hydrophobic segments. Therefore, the problem of high content of the organic solvent required for conventional dispersion of the pigment or the dye can be solved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A block copolymer, comprising:
a hydrophilic segment comprising a segment represented by formula (1): 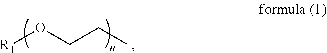
wherein n is a real number of 20 to 200, R₁ is a hydrogen atom, a phenyl group, a carboxyl group, an alkynyl group, an azide group, an amino group, maleimide or an alkyl group; and
a hydrophobic segment comprising a segment represented by formula (2): 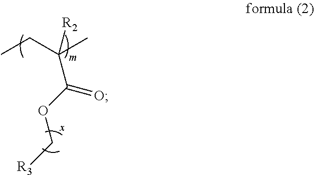
wherein m is a real number of 20 to 150, x is a real number of 0 to 10, R₂ is a hydrogen atom or a methyl group, and R₃ is a methoxy group, a phenyl group, a carboxyl group, an alkynyl group, an azide group, an amino group, maleimide or a methyl group.

2. The block copolymer of claim 1, wherein the hydrophilic segment comprises 80 wt % to 100 wt % of the segment represented by formula (1).

3. The block copolymer of claim 1, wherein the hydrophobic segment comprises 80 wt % to 100 wt % of the segment represented by formula (2).

4. The block copolymer of claim 1, wherein a weight ratio of the hydrophilic segment to the hydrophobic segment ranges from 90:10 to 10:90.

5. The block copolymer of claim 1, wherein an average molecular weight of the block copolymer ranges from 2000 g/mol to 20000 g/mol.

6. The block copolymer of claim 1, wherein a polymer dispersity index of the block copolymer ranges from 1.05 to 2.10.

7. A dispersant, comprising:
the block copolymer of claim 1.

8. A dye dispersion composition, comprising:
the dispersant of claim 7; and
a dye.

9. A pigment dispersion composition, comprising:
the dispersant of claim 7; and
a pigment.

10. A metal oxide dispersion composition, comprising:
the dispersant of claim 7; and
a metal oxide, wherein the metal oxide is titanium dioxide, zinc oxide, magnesium oxide, zirconium oxide or aluminum oxide.
